(19) United States
(12) Patent Application Publication
(10) Pub. No.: US 2021/0279742 A1
(43) Pub. Date: Sep. 9, 2021

(54) SYSTEM AND PROCESS FOR DETERMINING A METRIC AND PREDICTIVE ANALYSIS FOR COMPLIANCE OF CANNABIS RELATED PRODUCTS

(71) Applicants: Timothy John Los, Los Angeles, CA (US); Jacob Johnson, Bay Minette, AL (US)

(72) Inventors: Timothy John Los, Los Angeles, CA (US); Jacob Johnson, Bay Minette, AL (US)

(73) Assignee: Rante Corporation, Santa Monica, CA (US)

(21) Appl. No.: 16/812,576

(22) Filed: Mar. 9, 2020

(51) Int. Cl. G06Q 30/00; G06F 16/951; G06F 16/9536; G06Q 30/06; G06K 9/00

(52) U.S. Cl. CPC G06Q 30/018; G06F 16/951; G06K 9/00671; G06Q 30/0607; G06F 16/9536

(57) ABSTRACT

A cannabis compliance system allows for users and entities to track valid cannabis business activities, whether recreational or medical for compliance. Users and entities are able to validate licenses, activities, beneficial owners, and violations either within the cannabis industry and/or specific cannabis businesses and provide predictive analysis of cannabis data to make business decisions, to comply with legal and regulatory requirements, and establish compliance thresholds through public and private sources, including user-based inputs into the cannabis system from connected devices. The cannabis system may compute a compliance metric for cannabis businesses, which based upon cannabis data may derive multiple and weighted indicia. Users and entities can configure their own metric to meet their needs of compliance worthiness, including weighted indicia for business and compliance purposes.

### CROSS-REFERENCE TO RELATED APPLICATIONS

None.

### BACKGROUND

The embodiments herein relate generally to data processing, and more particularly to a system and process for determining a metric and determining predictive analysis of information for compliance of cannabis related products.

Currently, the cannabis industry is highly regulated with different jurisdictions imposing their own rules and schemes for compliance. Cannabis related businesses face numerous challenges in determining whether any of their processes or products comply with one or more of the State and local rules when their products or services are disclosed in commerce.

As can be seen there is a need for a system that analyzes and predicts whether a cannabis related product or process may comply with regulations for any particular jurisdiction.

### SUMMARY

In one aspect of the subject disclosure, a computer program product for tracking the validity of cannabis business activities comprises a non-transitory computer readable storage medium having computer readable program code embodied therewith. The computer readable program code is configured to: establish a database of cannabis businesses in an online platform service accessible by computing devices; send from a host server of the online platform, web crawlers through an online network connected to the host server, wherein the web crawlers retrieve online activity associated with one of the cannabis businesses in the database; analyze the retrieved online activity for content related to cannabis; determine whether the online activity is valid under terms of a license registered for the cannabis business; and presenting the determination of validity for the online activity in response to a user request for information related to the cannabis business.

In another aspect of the subject disclosure, a method for tracking the validity of cannabis business activities, comprises: establishing a database of cannabis businesses in an online platform service accessible by computing devices; sending from a host server of the online platform, web crawlers through an online network connected to the host server, wherein the web crawlers retrieve online activity associated with one of the cannabis businesses in the database; analyzing the retrieved online activity for content related to cannabis; determine whether the online activity is valid under terms of a license registered for the cannabis business; and presenting the determination of validity for the online activity in response to a user request for information related to the cannabis business.

### BRIEF DESCRIPTION OF THE FIGURES

The detailed description of some embodiments of the invention is made below with reference to the accompanying figures, wherein like numerals represent corresponding parts of the figures.

FIG. 1 is a block diagram of a system environment in which a cannabis validation and predictive analysis system operates, in accordance with an embodiment.

FIG. 2 is a block diagram of a cannabis validation, predictive analysis, and reporting system, in accordance with an embodiment.

FIG. 3 is a block diagram of the cannabis crawlers, in accordance with an embodiment.

FIG. 4 is a flowchart of method of data collection and ingestion of cannabis licenses, activities, beneficial owners, and violations from public and private sources, in accordance with an embodiment

FIG. 5 is a flowchart of a method of how a user configures output parameters, in accordance with an embodiment.

FIG. 6 is a block diagram with a flowchart of how machine learning and predictive analysis manages conflicting categories and data during collection and output, in accordance with an embodiment.

FIG. 7 is a flowchart of a method of how user generated data is compared against existing cannabis data within the cannabis system, in accordance with an embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF CERTAIN EMBODIMENTS

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. Like or similar components are labeled with identical element numbers for ease of understanding.

In general, embodiments of the disclosed subject technology provide a system and process for presenting content via a cannabis activity compliance system. The compliance system may for example, validate the operation of cannabis businesses under local and higher-level compliance jurisdictions, track the issuance or lack of cannabis licenses, identify beneficial ownerships of cannabis businesses, and identify cannabis-related violations retrieved from public and private sources. Sources may include for example, public records and user-based inputs into the cannabis tracking system. In an exemplary embodiment, a compliance metric (“metric”) may be generated based on the various sources of data input. In some embodiment, the metric indicia may be weighted based upon the configuration of input sources by the user or entity. In some embodiment, the cannabis compliance system may categorize, label, and classify photographs from social media sites to analyze patterns and determine the activities associated with the photographs or collection of photographs (“photo analysis”). The cannabis compliance system may analyze user-driven posts for patterns and sentiment related to cannabis activities (“social media analysis”). The cannabis catalogizing portion of the system may analyze news articles, blogs, and substantially similar news articles related to cannabis activities (“news analysis”). News analysis may interpret the title and body of the article to determine the type of cannabis activity being discussed; news articles are categorized by cannabis companies and cannabis activities and scored based upon risk interpreted from the text. For example, the news analysis process may extract the text from the title and the body of the article and compares the text, individual words, sentence structure, and phrases against a sentiment dictionary within the cannabis system; further, cannabis users can configure their own sentiment dictionary for specifically tailored risk scores. News articles may be categorized by business, as based upon the extracted text. Further, news articles are categorized by the cannabis activity, as based upon the sentiment and structure of the extracted text. News articles categorized by business may be further categorized by cannabis activity. In an exemplary embodiment, the cannabis system collects news articles from third-party sources, such as through a crawler, users, or third-party sources, and extracts the title of the article, such as “Cannabis Business X Sells to Underage Customers.” The cannabis system reads the preceding title and through analysis understands a cannabis business (“Business X”) engaged in transactions (“sells”) and the usage of the word “underage” is a construed as negative; consequently, the cannabis system assigns this article to Cannabis Business X and scores the news article as negative. The photo analysis and social media analysis may establish either an additional or separate indicium to the metric.

A cannabis compliance (“cannabis”) system, which may be operated through an online system or through an Automatic Programming Interface (API) integrated within other systems, allows its users to connect to and communicate with other systems and system users. Users may create accounts on the cannabis compliance system that allow either users or systems to validate cannabis data through internet-based crawlers and/or user-driven input variables. Further, the cannabis compliance system can analyze and determine patterns with both photo analysis and social media analysis with cannabis-related activities and associate those against either cannabis businesses or individuals, particularly if the individual is associated with cannabis data within the cannabis compliance system. Users may be either individuals or entities, such as but not limited to corporations or government agencies.

Due to the legalization of cannabis usage, as will be appreciated, aspects of the cannabis compliance system provide an ideal forum for both entities and individuals to increase compliance about cannabis organizations and their activities by presenting content items to a cannabis compliance system. As a result, conflicts between different municipalities, other local governments, states, the federal government, and internal compliance controls which may exist may be identified and the differences may be better understood and compliance between jurisdictions many be expanded upon.

Presenting content items to the cannabis compliance system users allows either an individual or entity to gain an understanding of licenses, beneficial owners, potential violations, and activities related to cannabis within different jurisdictions. Since the cannabis system can interpret photographs, articles, and social media, cannabis compliance systems users are able to determine the actions of cannabis businesses and their owners. These interpretations provide insights into the activities of cannabis businesses and their owners; further, the interpretations can establish a baseline, if desired, and a cannabis compliance score (“Cannabis Score”). A baseline provides acceptable compliance. A Cannabis Score provides both a numerical and grade level score that establishes whether the interpreted data is acceptable in terms of compliance practices of the appropriate jurisdiction. Due to jurisdictional differences, a Cannabis Score can vary. The differential scores reflect jurisdictional needs and cannabis data limitations; in one embodiment, State X collects violations whereas State X collects citations. The difference between a violation and citation can result in different Cannabis; consequently, in this embodiment, State X will more than likely not equal State Y for compliance comparison purposes. The cannabis system bridges conflicting jurisdictional Cannabis Score through a Global Cannabis Score (“GCS”) to compare. The GCS can be used in addition to the Cannabis Score. The GCS algorithm compares conflicting jurisdictional Cannabis Scores for normalization and adequate comparison; in the preceding embodiment, the conflict between State Y and State Z is compared and normalized to provide an equal comparison between different Cannabis Scores. In one embodiment, Cannabis Business A in State X has a Cannabis Score of 79% whereas Cannabis Business B in State Y has a Cannabis Score 81% with different cannabis data contributing to the Cannabis Scores. The GCS algorithm normalizes. The collected cannabis data allows the users to monitor both business and non-business activities of cannabis businesses and their owners for compliance purposes. In one embodiment, the cannabis system analyses the integrity and pattern of a photograph to determine if it raises a compliance concern. For example, the content of the photograph may show activity that may violate a regulatory rule in a jurisdiction. In one embodiment, the cannabis systems analyze articles, inclusive of blogs and editorials, from various sources to determine the activities and patterns in which a cannabis business and/or its owners are engaged. In one embodiment, the cannabis system analyzes social media platforms to determine the activities of cannabis businesses and determine patterns.

In some approaches, the collection, analysis, and predictive nature of cannabis licenses, activities, beneficial owners, and violations can be performed manually through searching online, reading articles, viewing photographs, and following social media handles. An individual may determine patterns, validate, and predict the cannabis businesses and activities. Validation determines whether the cannabis data is accurate based upon either external or internal sources. If the cannabis data cannot be validated, the cannabis data can be validated based upon the probability of a match to either internal or external sources. A prediction can be made based upon the cannabis data to determine how cannabis businesses is operating and what the cannabis business might do in the future based upon its activities. Predictions determine the projection of compliance practices and cannabis activities, whether for specific cannabis businesses and sectors. Compliance practice predictions may be based upon cannabis data and historical cannabis data to project adherence to compliance practices based upon specific jurisdiction; further, cannabis sector compliance is determined based upon the aggregate of compliance practices of all cannabis businesses within a sector. Activity predictions are based upon cannabis data and activity trends of either a separate cannabis business or a sector as a whole. For example, an individual might have to find the appropriate cannabis licensing agency to find licenses or file a Freedom of Information Action (FOIA) request to obtain this information; further, the individual will have to search for the business, view social media handles, and weigh their importance manually. Even though the preceding can be presented to either the individual or entity through a manual process, it may fail to address the dynamic legal and regulatory changes of the cannabis industry and, more specifically, provide an appropriate metric score.

As will be appreciated, the cannabis compliance system disclosed below is comprised of internet-based crawlers, user-based inputs, and machine learning for the output of collected data and predictive analysis of cannabis licenses, activities, beneficial owners, and violations through public and private sources without necessarily manual recording the information.

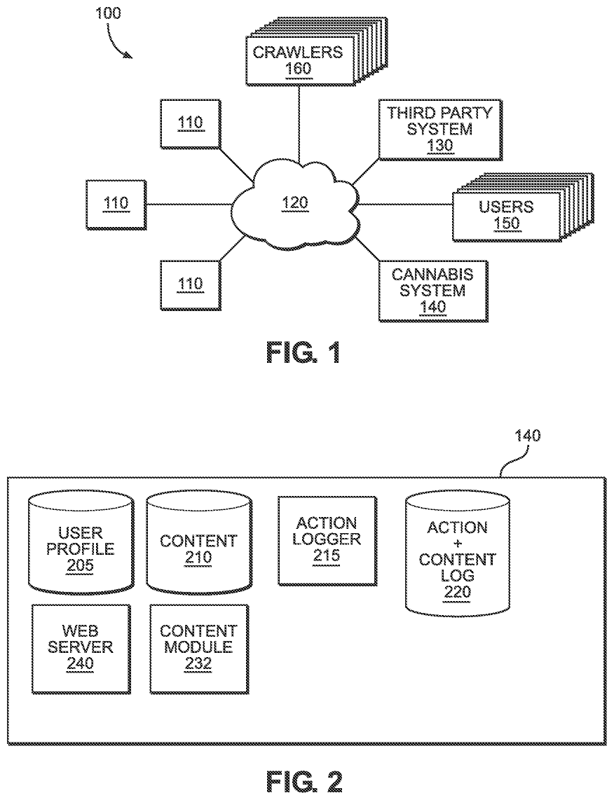

Referring now to FIG. 1, a high-level block diagram of a system environment 100 for a cannabis compliance system 140 is shown according to an exemplary embodiment. The system environment 100 shown by FIG. 1 comprises one or more client devices 110, a network 120, one or more third party systems 130, the cannabis compliance system 140, a crawler 160, and more or more user or entity 150. In alternative configurations, different and/or additional components may be included in the system environment 100. The embodiments described herein can be adapted to other suitable online systems and backend systems, including offline environments in which a network 120 is either not required or an intranet.

The client devices 110 are one or more computing devices capable of receiving user input as well as transmitting and/or receiving data via the network 120. The crawlers 160 are one or more systems capable of receiving data from public and private sources on the Internet as well as transmitting and/or receiving data via the network 120. In one embodiment, a client device 110 is a computer system, such as a desktop or laptop computer. Alternatively, a client device 110 may be a computing device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the cannabis compliance system 140. For example, a client device 110 executes a browser application to enable interaction between the client device 110 and the cannabis compliance system 140 via the network 120. In another embodiment, a client device 110 interacts with the cannabis compliance system 140 through an application programming interface (API) running on a native operating system of the client device 110, such as but not limited to IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

The crawlers 160 are configured to communicate with the cannabis compliance system 140 via the network 120. The crawlers 160 are accessible by client devices 110, third-party systems 130, and users 150.

One or more users or entity 150 are coupled to the network 120. The user or entity 150 communicates with the cannabis compliance system 140, which is further described in conjunction with FIG. 2. In one embodiment, the user 150 is an application provider communicating information describing applications for execution by a client device 110 or communicating data to client devices 110 for use by an application executing on the client device. A user or entity 150 may communicate information to the cannabis compliance system 140, such as cannabis licenses, cannabis activities, cannabis photographs, cannabis comments, cannabis violations, cannabis articles, and beneficial owners of cannabis businesses, cannabis content, or information to one or more client devices 110.

One or more third party systems 130 may be coupled to the network 120 for communicating with the cannabis compliance system 140, which is further described below in conjunction with FIG. 2. In one embodiment, a third-party system 130 is an application provider communicating information describing applications for execution by a client device 110 or communicating data to client devices 110 for use by an application executing on the client device 110. In other embodiments, a third-party system 130 provides content or other information for presentation via a client device 110. In other embodiments, a third-party system 130 provides content or other information for presentations via a client device 110 utilizing the crawler 160. A third-party website 130 may also communicate information to the cannabis compliance system 140, such as licenses, activities, content, or information about an application provided by the third-party website or backend software 130.

FIG. 2 is an example block diagram of an architecture of the cannabis compliance system 140. The cannabis compliance system 140 shown in FIG. 2 may include a user profile 205, content 210, action logger 215, action and content logger 220, web server 240, and the content module 232. In some embodiments, the web server 240 may be a host server which administers embodiments as an online platform service. The cannabis compliance system 140 functions from crawlers 160, user devices 110, or a combination of the preceding elements. Conventional components such as network interfaces, security functions, load balancers, failover servers, management and network operations consoles, and the like are not shown to not obscure the details of the system architecture.

Each user of the cannabis compliance system 140 is associated with a user profile, which is stored in the user profile 205. A user profile may include declarative information about the user that was shared by the user and inferred by the cannabis compliance system based upon cannabis data. In one embodiment, a user profile might include cannabis data submitted by either other users through content 210 and/or crawlers 160 from the cannabis compliance system 140. Examples of information stored in a user profile includes personally identifiable and business information, cannabis licenses, cannabis activities, cannabis activities, beneficial ownership of cannabis businesses, and cannabis licenses. In addition, a user profile might include other information obtained by the crawlers 160, for example, images, news and blog articles, and videos and, in certain embodiments, might be classified, labeled, and categorized based upon the requirements of cannabis compliance system 140 shown in FIG. 6.

While user profiles are frequently associated with individuals, allowing individuals to interact with each other via the cannabis compliance system 140, user profiles may also be stored for entities such as businesses or organizations, or agencies. This allows an entity on the cannabis system 140 to connect and exchange information with other cannabis compliance system 140 users. In on embodiment, a government entity can share their licensing information with either another government agency and/or another entity may verify cannabis-related information.

The content storage module 210 stores objects related to various type of cannabis indicia of the user profile 205. Examples include licenses, business registrations, cannabis activities (e.g., recreational, medical, hemp, etc.), social media handles, and news articles. Cannabis compliance system 140 users may enter and review their own content. In one embodiment, objects in the content 210 represent single pieces of content, or content “items.” In one embodiment, a cannabis compliance system 140 user may have their information automatically added from crawlers 160, other users 150, and third-party systems 130.

The action logger 215 may receive transactions and actions either performed by the user or other users related to content 210 and executed by crawlers 160. Examples include updates to their licenses, beneficial ownership, corporate structure changes, violations, executed crawler activity and user generated data ingestions shown in FIG. 4. In addition, a number of actions may involve an object and one or more particular actions, so these actions are associated with those users as well and may be stored in the action log 220.

The action and content logger 220 is used by the cannabis compliance system 140 to track and monitor cannabis data ingestion from users 150, third-party systems 130, and crawlers 160. The action and content logger 220 may be a software module stored in the web server 240.

The web server 240 links the cannabis compliance system 140 via the network 120 to the one or more client devices 110, as well as to the one or more third party systems 130 and crawlers 160. The web server 140 serves web pages, as well as other web-related content, such as JAVA®, FLASH®, XML and so forth. The web server 240 may receive and route messages between the cannabis system 140., the client device 110, third-party systems 130, and crawlers 160. The web server 240 may provide application programming interface (API) functionality to send data directly to native client device operating systems, such as IOS®, ANDROID™ WEBOS® or RIM®. The web server can provide the user interface mentioned above including the weighted metric.

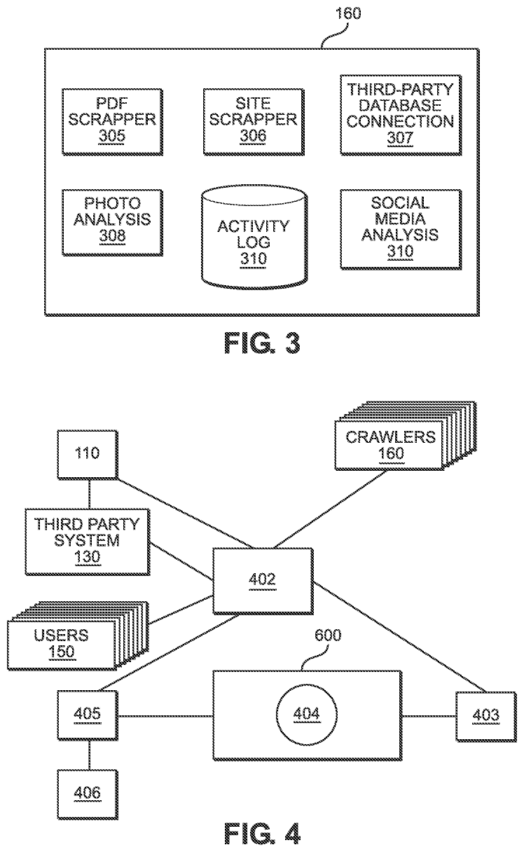

FIG. 3 is an example block diagram of the internet-based crawlers of the cannabis system 140. The crawler 160 of the cannabis compliance system 140 may include a PDF scraper 305, site scraper 306, third party database connections 307, photo analysis 308, social media analysis 309, and an activity logger 310 (“crawler components”). The activity logger 310 may provide a historical record of all actions performed by each crawler component 160 within the cannabis system 140. In one embodiment, the cannabis compliance system 140 relies upon the crawler 160 for cannabis data where user generated data is not supplied through a client device 110, users or entities 150, or a third-party system 130. The crawler components 160 work either independently, simultaneously, or dependent upon each other to obtain cannabis data.

The PDF scraper 305 of the crawler 160 of the cannabis compliance system 140 extracts the PDF data and ingests the extracted data into the cannabis compliance system 140 which may be processed through the content module 232 of the cannabis compliance system 140 and may be processed according to the method shown in FIG. 4.

The site scraper 306 of the crawler 160 of the cannabis compliance system 140 extracts either Internet or intranet data into the cannabis compliance system 140 and which may be processed through the content module 232 of the cannabis compliance system 140 and may be processed according to the method shown FIG. 4.

The Third-party database connection 307 of the crawler 160 of the cannabis compliance system 140 allow users 150 and third-party systems 130 to connect to the cannabis compliance system 140 to exchange data from third-party database providers, such as but not limited to Microsoft SQL, Oracle DB, and MySQL. Users 150 and third-party systems 130 configure the connection relationships between the third-party database connection 307 and the cannabis system 140.

The photo analysis 308 of the crawler 160 of the cannabis compliance system 140 extracts photos from online sources including for example, third-party social media websites, into the cannabis compliance system 140 and which may be processed through the content module 232 of the cannabis compliance system 140 and may be processed according to the method shown FIG. 4.

The social media analysis engine 309 of the cannabis compliance system 140 extracts comments from third-party social media websites, such as but not limited to Twitter, Instagram, Facebook, online forums, and comments sections of websites into the cannabis compliance system 140 and which may be processed through the content module 232 of the cannabis compliance system 140 and may be processed according to the method shown FIG. 4.

FIG. 4 is a process for data ingestion according to an exemplary embodiment from users 150, third-party systems 130, or crawlers 160 into the cannabis compliance system 140. The cannabis compliance system 140 receives the cannabis data 402 and analyses the data 402. The cannabis compliance system 140 either matches the cannabis data to existing categories 405 or, if unable to match, creates a new category and assigns a relationship to an existing category 404 for the cannabis data. The cannabis data is assigned to parameters from categories 406 for the cannabis system 105.

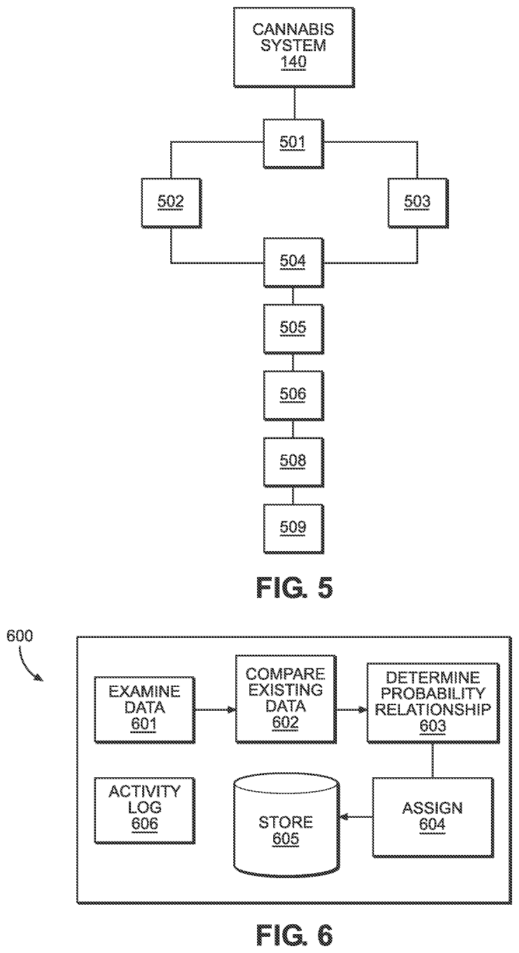

FIG. 5 is a process for cannabis data output according to an exemplary embodiment which may be based upon customized filters and conditional logic 501 of the cannabis compliance system 140 for a desired output 509. The presented content of the cannabis data from the cannabis system 140 is displayed to the users 150. Through either client devices 110, users 150 and/or third-party systems 130, either pre-defined filters 502, user-driven and customizable conditional statements 507, the content presented may be preliminary results 504. After preliminary results 504 are presented, client devices 110 by users 150 and/or third-party systems 130 can further customize 505 and drill down into the presented cannabis data based upon their requirements 506. Client devices 110, users 150 and/or third-party systems 130 are able to validate licenses, photographs and videos, activities, violations, beneficial ownerships, and predict patterns to determine adherence to compliance 508. The cannabis system 140 validates cannabis licenses from crawlers 160, third-party systems 130, and users 150 to determine the validity of a cannabis license (“license validity”). License validity is either determined by a direct validation from crawlers 160 or third-party systems 130 based upon either the structure (numerical, alphabetical, or combination) and/or existence of a cannabis license; if, however, a cannabis license cannot be validated, the cannabis system compares the cannabis license structure against existing data 600 to determine license validity 600 based upon a probability relationship 603. Based upon the probability 603 to existing cannabis licenses 602 within the cannabis system 140, the cannabis license is assigned 604 and stored 605 within the cannabis system 140 and license validity is assessed based upon the probability relationship 603. In one embodiment, the cannabis system collects a cannabis license ABC123 from a user 150. Cannabis license ABC123 is compare against existing cannabis data within the cannabis system 140, including third-party systems 130 and crawlers 160. For purposes of this embodiment, cannabis license ABC123 does match to any existing data; consequently, the cannabis system 140 examines the 602 and compares the structure of the cannabis license to existing data 602 and determines it matches with State X with a high probability 603. A probability match is based upon the structure of the cannabis license and the percentage the particular cannabis license belongs to a specific state and/or country; if, however, the cannabis system 140 cannot establish a probability match 603 for an unassigned cannabis license, then the cannabis license is assigned based upon its relevance to a specific state and/or country.

The cannabis system 140 ingests collected photographs and videos from crawlers 160, third-party systems 130, and users 150 to establish label and risk tolerance for compliance purposes. The cannabis system 140 contains default and user-driven content dictionary. A content dictionary includes images and videos that are compared against ingested cannabis data for videos and photographs. A content dictionary is used to assess the content of a photograph and labels the videos and photographs and subsequently determines risk to the video and photograph based upon the label. The risk is based upon the label; however, risk can be configured by the user. Ingested photographs and videos are analyzed to determine the content. In one embodiment, the cannabis system 140 ingests photographs and videos from crawlers 160 from various third-party websites. The ingested photographs and videos are compared against the content dictionary.

The cannabis system 140 ingests social media, blogging, and news sites (“activities”) of cannabis businesses and their owners from crawlers 160, third-party systems 130, and users 150. The cannabis system 140 aggregates these activities to create profiles on cannabis businesses and their owners (“activity profiles”). Activity profiles provide an aggregate of all activities on either a specific cannabis business and/or the owner(s) of a cannabis business; in addition, each activity profile has sentiment and compliance scores and flags for each activity, as well as total score and flag for the activity profile. Activity profiles are linked to establish a hierarchical perspective to show relationships between cannabis businesses and their beneficial owners, customers, and vendors. Sentiment scores and flags are determined by a default sentiment database and amendable by the user for specific needs. Sentiment is determined by the words and sentence structure to determine the tone of the comment, post, news article. Compliance is determined by the sentiment to determine risk. In one embodiment, a user 150 of the cannabis system 140 is able to select a specific company and view their activity profile; as a result, the user is able to see all their activities, sentiment and compliance scores and flags, and an expansive insight into company's beneficial owners, customers, and vendors. In another embodiment, a user 150 of the cannabis system 140 can evaluate each activity and view their sentiment and compliance scores and flags.

The cannabis system 140 ingests violations of cannabis businesses and their owners from crawlers 160, third-party systems 130, and users 150. A violation is an act that has been recorded against a cannabis business by either a government agency or a private citizen against a cannabis company. The cannabis system 140 ingests violations and assigns those violations against either a cannabis business or the beneficial owners of a cannabis business for users 150 of the cannabis system 140. If a violation is unassignable, the cannabis system 140 examines the data 601 and compares either the violation type and/or violation structure against existing violation data 602 allows the cannabis system 140 to determine how to assign the unassigned violation based upon the probability match 603 against existing data 602. The violation is assigned 604 and stored 205 within the cannabis system 140. In one embodiment, a crawler 160 collects and stored violations from State Y into the cannabis system 140. In another embodiment, a user 150 enters a violation against a beneficial owner of a cannabis business; however, the user does not enter any personally identifiable information of the beneficial owner of a cannabis business. In this embodiment, the cannabis system 140 examines the license data 601 and compares the inputted data from the user 150 against existing data 602 and determines the match by analyzing all violations within the cannabis system 140. Once the probability match is made, then the violation is assigned 604 and stored 605.

The cannabis system 140 ingests the beneficial owners of cannabis business owners from crawlers 160, third-party systems 130, and users 150. Beneficial owners are the owners of cannabis businesses. Beneficial owners can be either individuals or legal entities who hold an equity within a cannabis business. Beneficial owner relationships are determined from crawlers 160, third-party systems 130, and users 150. Crawlers 160 scan and extract beneficial owner data from third-party sites. Third-party systems 130 ingest beneficial owners from the third-party systems 130. Users input beneficial owner information manually 150 Extracted beneficial owner data is assigned to cannabis businesses within the cannabis system 140. . If a cannabis business is not listed within the cannabis system 140 from the ingested beneficial owner data, then the cannabis business is known. If beneficial owner data cannot be assigned, then the beneficial owner data is examined 601, compared against existing data 602, and, based upon a probability match 603, assigned 604 and stored 605 against a cannabis business. The probability match 603 can be based upon activities, activity profiles, and existing relationships within the cannabis system 140. In the preceding, the reverse is true if the cannabis business of the beneficial owner is either not known or not within the cannabis system 140. In one embodiment, a crawler obtains beneficial owners listed from State Z and assigns the beneficial owners to existing cannabis business. In another embodiment, the cannabis system 140 ingests beneficial owner data from a third-party system 130; however, the beneficial owner data does not match any cannabis business within the cannabis system 140. In this embodiment, the cannabis system 140 examines the data 601 and compares to existing data 602, including activities and activity profiles; as a result, the beneficial cannabis data is matched and assigned 605 to a cannabis business.

Providing a Weighted Metric for Cannabis Compliance

FIG. 6 is an example block diagram with an illustrative flowchart of an example of how the cannabis compliance system 140 analyses, configures, and stores conflicting cannabis data during ingestion 402 from crawlers 160, third-party systems 130, users 150, and client devices 110 when an existing category does not existing 405 within the cannabis system 140. Cannabis data is analyzed 601 and compared against existing data 602 within the cannabis system 140. The ingested data is compared based upon the data composition type (e.g., numbers, letters, combination of numbers and letters, and names). Based upon the composition type, a probability is created 603 and compared against the probability match threshold. Based upon the probability of the composition between the ingested data 402 and existing data 602, the cannabis data is assigned 604 based upon the probability match threshold 603 and stored 605 within the cannabis system 140.

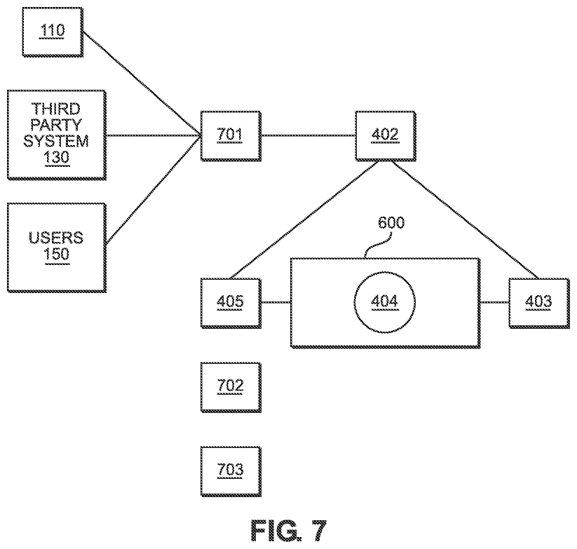

FIG. 7 illustrates a flow diagram of an example of user generated data ingestion 402 of cannabis data into the cannabis compliance system 140 from client devices 110, third-party systems 130, and users 150 through a content presenter 701. When cannabis data is ingested 402 into the cannabis system 140, it is either match with existing cannabis data 405 or, if no matches, analyzes and matched based upon a probability match threshold 600. After the preceding occurs, a result output occurs 702 and validation of the cannabis data occurs 703.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Any combination of one or more computer readable media may be utilized. In the context of this disclosure, a computer readable storage medium may be any tangible or non-transitory medium that can contain, or store a program for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing.

Aspects of the disclosed invention are described below with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor 16 of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A computer program product for tracking the validity of cannabis business activities, the computer program product comprising a non-transitory computer readable storage medium having computer readable program code embodied therewith, the computer readable program code being configured, when executed by a computer processor to:
establish a database of cannabis businesses in an online platform service accessible by computing devices;
send from a host server of the online platform, web crawlers through an online network connected to the host server, wherein the web crawlers retrieve online activity associated with one of the cannabis businesses in the database;
analyze the retrieved online activity for content related to cannabis;
determine whether the online activity is valid under terms of a license registered for the cannabis business; and
presenting the determination of validity for the online activity in response to a user request for information related to the cannabis business.

2. The computer program product of claim 1, wherein in the event the determination of validity is not a direct determination of validity for the online activity, further comprising computer readable program code configured to:
compare the online activity to activity data stored in the host server;
generate a probability match score; and
determine whether the online activity is valid under the terms of the license based on the probability score exceeding a threshold for valid or invalid activity.

3. The computer program product of claim 1, further comprising computer readable program code configured to:
generate a cannabis compliance score for the cannabis business based on the determination of validity for the online activity, wherein the cannabis compliance score represents compliance with cannabis business practices for a jurisdiction.

4. The computer program product of claim 1, wherein the content of the online activity includes: articles, weblogs, news posts, reviews, social media posts, and photographs that include an association with the cannabis business.

5. The computer program product of claim 4, further comprising computer readable program code configured to:
categorize, label, and classify content in the photographs;
analyze the content in the photographs for patterns of cannabis activity; and
determine specific cannabis activities from the analyzed content.

6. The computer program product of claim 4, further comprising computer readable program code configured to:
analyze content in the social media posts for patterns of cannabis activity; and
determine a sentiment for the patterns of cannabis activity from the analyzed content.

7. The computer program product of claim 4, further comprising computer readable program code configured to:
analyze content in the articles, weblogs, news posts, and reviews for potential negative actions;
determine from the analyzed content whether a cannabis business engaged in activity associated with a risk factor; and
generate a compliance risk score that is based on whether the cannabis business engaged in activity associated with the risk factor.

8. The computer program product of claim 1, further comprising computer readable program code configured to:
analyze the terms of the license registered for the cannabis business for a license structure;
compare the license structure of the license for the cannabis business to stored cannabis license data;
determine a probability match for the license for the cannabis business to a jurisdiction's license structure based on the stored cannabis license data; and
perform the determination of validity for the online activity based on rules for a jurisdiction of the probability match.

9. A method for tracking the validity of cannabis business activities, comprising:
establishing a database of cannabis businesses in an online platform service accessible by computing devices;
sending from a host server of the online platform, web crawlers through an online network connected to the host server, wherein the web crawlers retrieve online activity associated with one of the cannabis businesses in the database;
analyzing the retrieved online activity for content related to cannabis;
determine whether the online activity is valid under terms of a license registered for the cannabis business; and
presenting the determination of validity for the online activity in response to a user request for information related to the cannabis business.

10. The method of claim 9, wherein in the event the determination of validity is not a direct determination of validity for the online activity, further comprising:
comparing the online activity to activity data stored in the host server;
generating a probability match score; and
determining whether the online activity is valid under the terms of the license based on the probability score exceeding a threshold for valid or invalid activity.

11. The method of claim 9, further comprising:
generating a cannabis compliance score for the cannabis business based on the determination of validity for the online activity, wherein the cannabis compliance score represents compliance with cannabis business practices for a jurisdiction.

12. The method of claim 9, wherein the content of the online activity includes: articles, weblogs, news posts, reviews, social media posts, and photographs that include an association with the cannabis business.

13. The method of claim 12, further comprising:
categorizing, labeling, and classifying content in the photographs;
analyzing the content in the photographs for patterns of cannabis activity; and
determining specific cannabis activities from the analyzed content.

14. The method of claim 12, further comprising:
analyzing content in the social media posts for patterns of cannabis activity; and
determining a sentiment for the patterns of cannabis activity from the analyzed content.

15. The method of claim 9, further comprising:
analyzing the terms of the license registered for the cannabis business for a license structure;
comparing the license structure of the license for the cannabis business to stored cannabis license data;
determining a probability match for the license for the cannabis business to a jurisdiction's license structure based on the stored cannabis license data; and
performing the determination of validity for the online activity based on rules for a jurisdiction of the probability match.
